(19) United States
(12) Patent Application Publication
(10) Pub. No.: US 2023/0028941 A1
(43) Pub. Date: Jan. 26, 2023

(54) RATE ESTIMATION CONGESTION CONTROL FOR TRANSMITTED MEDIA

(71) Applicant: Intel Corporation, Santa Clara, CA (US)

(72) Inventors: Brandon GAVINO, Beaverton, OR (US); Tomasz FRANKOWSKI, Gdansk (PL); Dmitry LAVROV, Spring, TX (US)

(73) Assignees: Intel Corporation, Santa Clara, CA (US); Intel Corporation, Santa Clara, CA (US)

(21) Appl. No.: 17/958,344

(22) Filed: Oct. 1, 2022

(51) Int. Cl. H04L 47/2416; H04L 47/27; H04L 47/52; H04L 47/215

(52) U.S. Cl. CPC H04L 47/2416; H04L 47/27; H04L 47/52; H04L 47/215

(57) ABSTRACT

Examples described herein relate to media transmission. In some examples, based on increased available bandwidth to transmit media data to a receiver device and based on unavailability of media data, fill data can be into a network data buffer for transmission in one or more packets. In some examples, based on increased available bandwidth to transmit media data to a receiver device and based on availability of media data, media data can be provided into the network data buffer for transmission to the receiver device.

### BACKGROUND

Transmission rates of media and data traffic based on bitrate or latency estimation over User Datagram Protocol (UDP) or quick UDP Internet Connections (QUIC)-based connections can be sensitive to fluctuations in available network bandwidth. For example, an available network bandwidth could be present for a short duration and a high rate burst allocated by estimated rate measurement timings and window lengths. A burst period can destabilize and suppress media quality rates and cause hunting between different quality levels of media. Media quality can increase during the burst data rate for a short duration of time, then experience a backoff to a lower quality until the network bandwidth burst period resets. Burst and backoff can result in media frame losses or reduced media quality that can substantially impact user experience in terms of changing and degraded visual and audio quality.

### BRIEF DESCRIPTION OF THE DRAWINGS

FIG. 1 depicts an example system.

FIG. 2 depicts an example of synchronous and asynchronous network application program interface (API) flows.

FIG. 3 depicts examples of media quality.

FIG. 4 depicts an example process.

FIG. 5 depicts an example of lowering of transmit bitrate.

FIG. 6 depicts an example of transmit bitrate increase scenarios.

FIG. 7 depicts an example of selecting bitrate profiles based on fill data size.

FIG. 8 depicts an example of scaling compression for resource utilization at a sender host server based on transmit bandwidth estimates.

FIG. 9 depicts a characteristic misestimation of bandwidth and effect on media quality.

FIG. 10 depicts an example system.

FIG. 11 depicts an example system.

### DETAILED DESCRIPTION

At least to attempt to avoid a burst and backoff scenario, fill data can be inserted into transmitted packets so that an available transmit data rate is utilized. The fill data can prevent the buildup of tokens during a burst period and can maintain the current level of quality without spurious drops to higher or lower quality levels to attempt to provide stable media quality for bitrate sensitive traffic. During a change in available transmit rate, by performing fill data padding during rate probing, build-up of burst capacity can be prevented and stable media quality can be achieved. Use of fill data can be used at least in situations where media data is not available to transmit, such as during live streaming, or there are discrete media bitrate levels. Fill data can include zero-fill data or data to assist a receiver to display or output a higher quality level media. Multiple media data traffic types can be supported and media quality can increase as available transmit bandwidth increases.

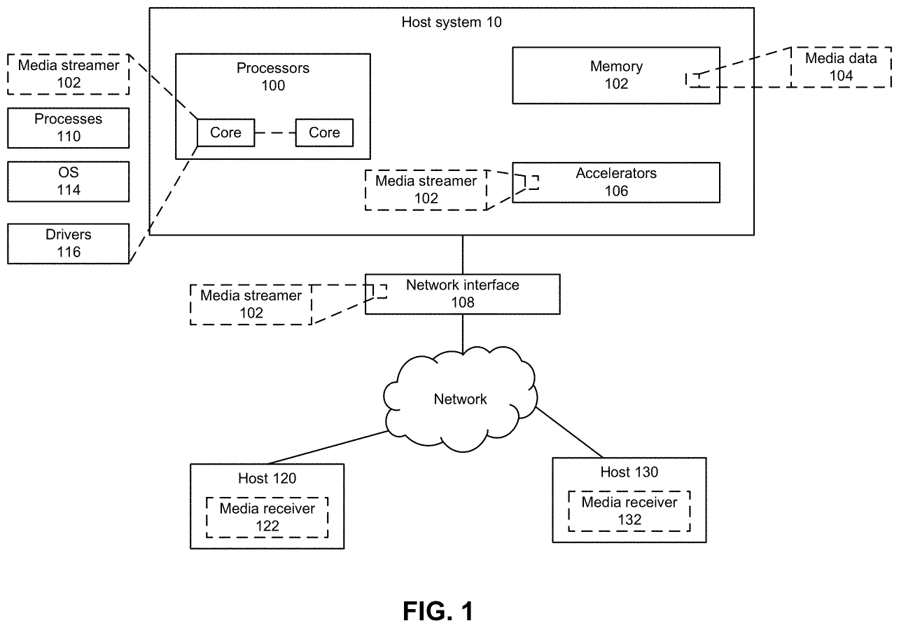

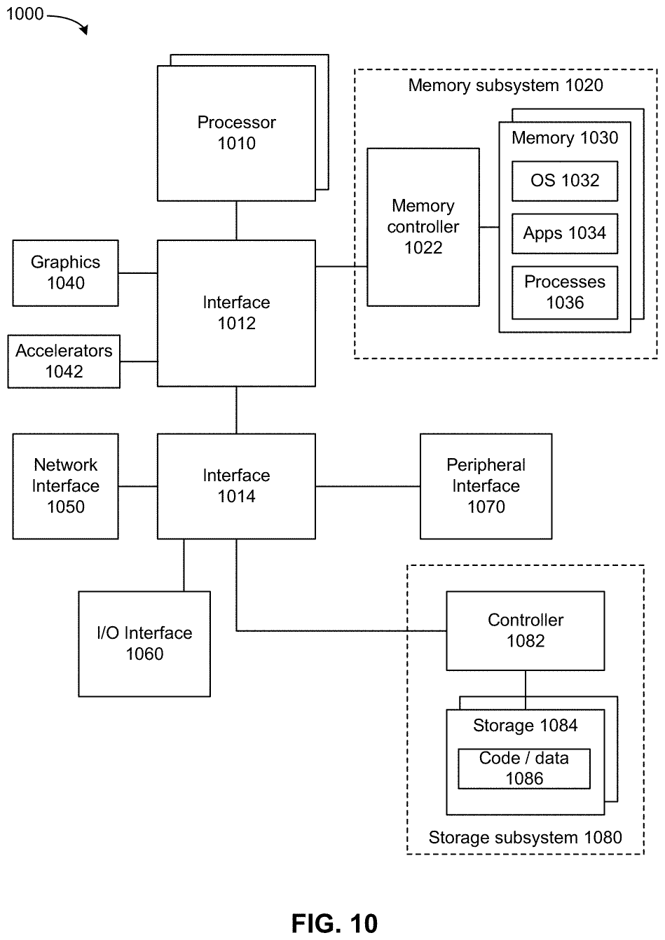

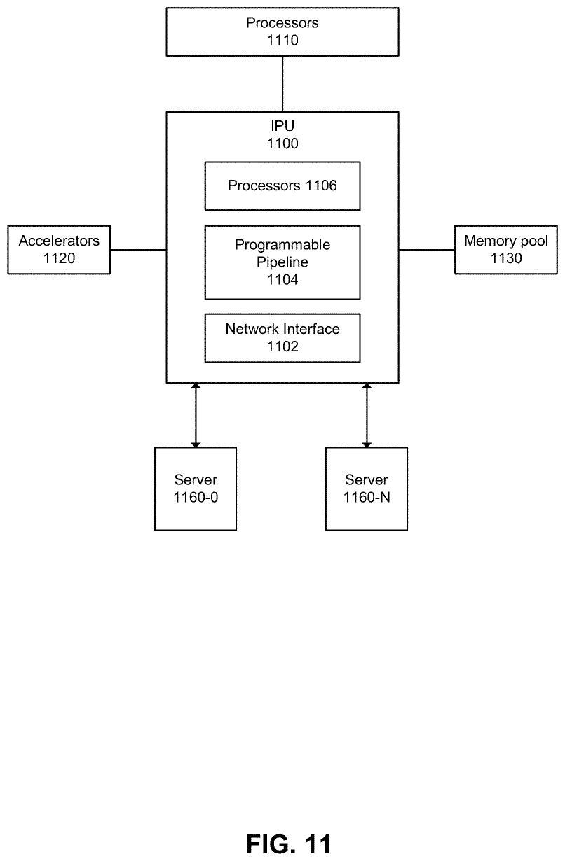

FIG. 1 depicts an example system. Host system 10 can include processors 100 that execute one or more of: media streamer 102, processes 110, operating system (OS) 114, and device driver 116. Various examples of hardware and software utilized by the host system are described at least with respect to FIGS. 10 and 11. For example, processors 100 can include a central processing unit (CPU), graphics processing unit (GPU), accelerator, or other processors described herein. Processes 110 can include one or more of: application, process, thread, a virtual machine (VM), microVM, container, microservice, or other virtualized execution environment.

Portions of media streamer 102 can be executed as part of one or more of: processes 110, operating system 114, network stack in operating system 114, driver 116, circuitry in one or more accelerators 106, and/or processor-executed software in network interface device 108. Media streamer 102 can cause media data 104 to transmitted to one or more clients through one or more connections such as, but not limited to, host 120 and host 130. For example, media data 104 can include one or more of: video, audio, still images, or metadata. Media data 104 can be displayed as part of a streaming media, virtual reality (VR), or augmented reality (AR) experience. As described herein, various quality levels of media data 104 are available for transmission to host 120 and/or host 130.

Media streamer 102 can utilize streaming protocols that allow for control of media playback, recording, or pausing to provide real-time control of media streaming from the server to a client such as video-on-demand (VOD) or media on demand. In some examples, media streamer 102 can generate media as part of a content delivery network (CDN). A CDN can include geographically distributed servers that deliver content, including media to destination devices. Transmission of streaming video and audio can be consistent with Real-time Transport Protocol (RTP). An example of RTP protocol is described in RFC 3550 (2003). Transmission of streaming video and audio can be consistent with a standard from Society of Motion Picture and Television Engineers (SMPTE) 2110 (2018). Packet formats to map MPEG-4 audio/video into RTP packets is specified at least in RFC 6416 (2011). Video payload formats can include, but are not limited to, H.261, H.263, H.264, H.265, and MPEG-1/MPEG-2. Audio payload formats can include, but are not limited to, G.711, G.723, G.726, G.729, GSM, QCELP, MP3, and DTMF. Transmission of streaming video and audio can be consistent with media streaming services such as Dynamic Streaming over HTTP (DASH) protocol or HTTP Live Streaming (HLS). Media can be transmitted using Web Real-Time Communication (WebRTC) or UDP/IP (Internet Protocol) based streaming systems (e.g., Real Time Streaming Protocol (RTSP), quick UDP Internet Connections (QUIC), SMTPE 2022, Session Initiation Protocol (SIP) (RFC 3261 (2020)), ITU Telecommunication Standardization Sector (ITU-T) H.323 (1996), IR.94 (IMS Profile for Conversational Video Service), Jingle (XMPP), etc.). Media can be transmitted using Real-Time Messaging Protocol (RTMP), Secure Reliable Transport (SRT), Transmission Control Protocol (TCP), Microsoft Smooth Streaming (MSS), UDP, or QUIC.

For example, network interface 108 can form packets with IP and UDP headers and that include RTP media packages, for transmission at least to host 120 and/or host 130. In connection with packet transmission to a destination, network communications 264 can perform Multiprotocol Label Switching (MPLS) routing, VxLan encapsulation protocol, Load Balancing, Equal-cost multipath (ECMP), or other operations. For example, UDP datagrams can be transmitted over Internet Protocol (IP) protocol with a unique IP address and dedicated UDP port per stream type (e.g., video, audio, or ancillary information).

Media streamer 102 can utilize a token bucket approach for bandwidth allocation whereby tokens are put into a token bucket at a preset rate and a packet can be transmitted if sufficient tokens are available. A token bucket can be used to regulate bandwidth during a burst cycle. A token bucket can attempt to prevent a single connection or client from heavily utilizing available bandwidth at the expense of bandwidth available to other connections or clients. Depending on the congestion avoidance approach of the traffic, packets can either be dropped, queued, or marked to indicate rate limiting. Tokens can be accumulated for connections/clients that use less than an allotted bytes/frame (or bytes/time period) to allow the connection/client to spend these tokens during a burst period.

Media streamer 102 can perform adaptive bitrate streaming to adjust video quality based on network conditions such as congestion. As described herein, based on an increase in transmit bandwidth and insufficient media data 104 being available for transmission using one or more packets, media streamer 102 can provide fill data for insertion into the one or more packets to attempt to reduce or steady an amount of available tokens as a result of the available increased transmit bandwidth to host 120 and/or host 130. Note that a transmit bandwidth level is associated with a connection between host system 10 and host 120 and another transmit bandwidth level is associated with a connection between host system 10 and host 130. In some cases, a level of quality of media data 104 transmitted to host 120 and/or host 130 may not increase for a duration of the increase in transmit bandwidth to attempt to avoid a burst and backoff scenario occurring at media receiver 122 and/or media receiver 132. Media receiver 122 can include a CDN or media player executed by host 120. Media receiver 132 can include a CDN or media player executed by host 130. In some cases, fill data can include media data of higher quality level to permit media receiver 122 and/or media receiver 132 to played back media during a burst. Various examples of fill data are described herein.

Host 120 and/or host 130 can indicate delays in receipt of media data from host 10 using QUIC, High Precision Congestion Control (HPCC), in-network telemetry (INT), or other manners. HPCC is a congestion control system utilized for remote direct memory access (RDMA) communications that provides congestion metrics. HPCC is described at least in Li et al., “HPCC: High Precision Congestion Control,” SIGCOMM (2019). HPCC leverages in-network telemetry (INT) (e.g., Internet Engineering Task Force (IETF) draft-kumar-ippm-ifa-01, “Inband Flow Analyzer” (February 2019)) to convey precise link load information.

For example, media streamer 102 can determine transmit bandwidth based on goodput. Goodput can indicate a number of information bits delivered by a network to a destination per unit of time and can exclude protocol overhead and retransmitted packets.

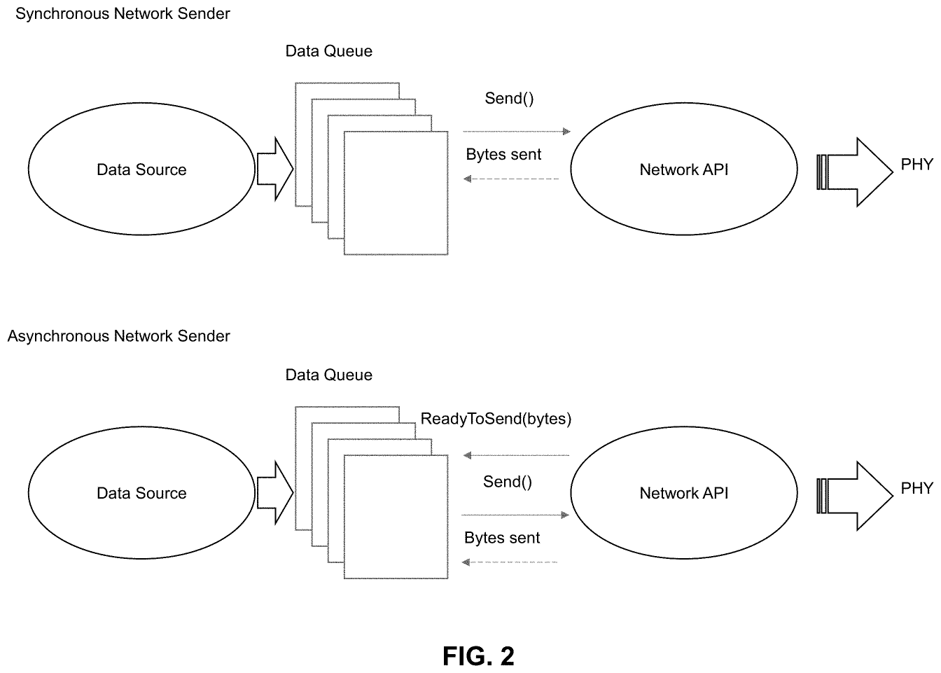

FIG. 2 depicts an example of synchronous and asynchronous network application program interface (API) flows. A network stack in an OS or media streamer can provide different approaches to send media data to a receiver endpoint over a network. The network stack can provide a synchronous interface or an asynchronous (callback-type) interface. A synchronous interface can involve a data source issuing an API to the network stack to cause media data to be transmitted through a network interface physical layer interface (PHY) to a receiver. An asynchronous interface can involve the network stack indicating that the network interface is ready to send data and requesting a data source to provide media data for transmission.

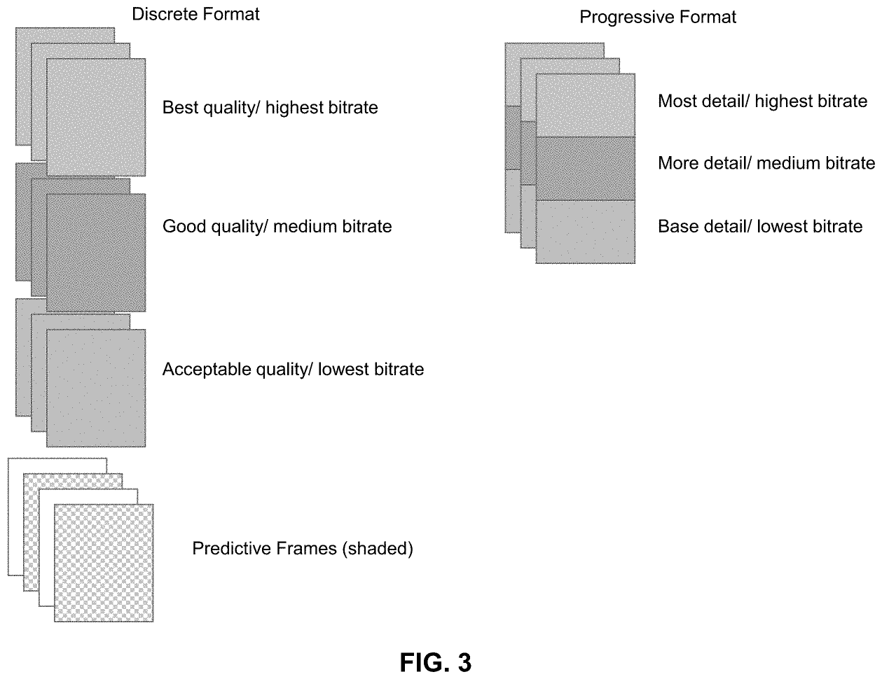

FIG. 3 depicts examples of media quality. Media can have different levels of quality available and a level of quality of media transmitted can correspond to available bandwidth bitrate profiles. Various levels of quality of media are available for discrete and progressive formats. Best quality and highest bitrate can refer to a highest number of bits used to encode pixels and audio of media whereas acceptable quality and lowest bitrate can refer to a lowest number of bits used to encode the same media. Use of best, highest, and lowest can refer to relative levels and not absolute levels. For discrete format media, frames can be independently encoded. For progressive format media, media can be encoded as a difference. Examples of progressive formats include standards from Moving Picture Experts Group (MPEG) and High Efficiency Video Coding (HEVC).

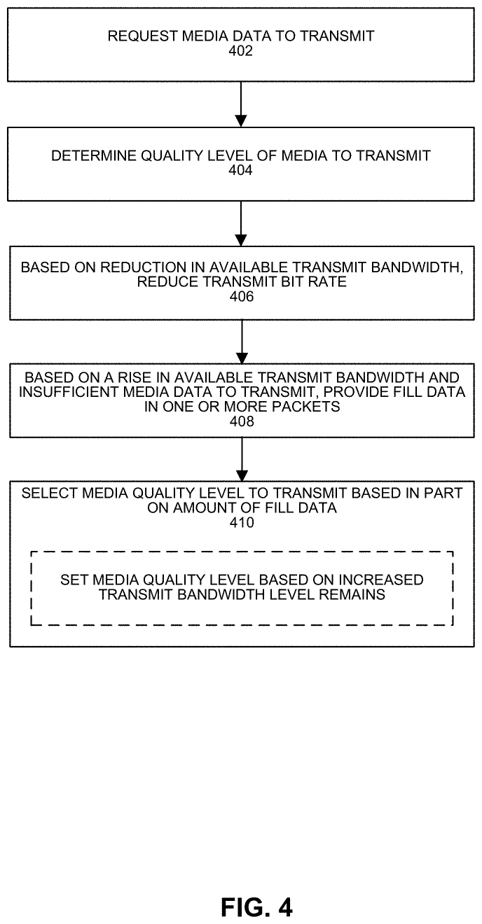

FIG. 4 depicts an example process to determine content of network packets to transmit. The process can be performed by a sender device including one or more of: a media streaming process, network stack, operating system, network interface device, or other software and/or circuitry. The process can be applied in a synchronous or an asynchronous (e.g., callback-type) interface for media streaming. To prevent a mis-estimation of available bandwidth to transmit media or other data to a receiver, the sender can insert pad or filler data in one or more packets transmitted to a receiver. When or after a connection has been established to clients (receivers) per link from the server (sender), the following operations can take place. At 402, a sender stream queue manager can determine a ready-to-send state and request media data from a media data buffer of sender to send media data to one or more receivers.

At 404, a quality level of media to send to a client receiver can be determined. For example, a level of media can start at a high quality level, medium level, or low level. At 406, based on an indication of a reduction in available transmit bandwidth, a transmit bit rate can be reduced. For example, for a stream, based on a sender receiving an indication of a delay threshold event (e.g., inability to transmit within frame time) or media data was not received in time (e.g., delayed packet receipt acknowledgement (ACK) feedback from receiver or negative ACK feedback from receiver), a media quality level can be dropped to a lower level to reduce utilized transmit bitrate. Other examples of determining reduced transmit bandwidth are described herein and can include receipt of congestion indications.

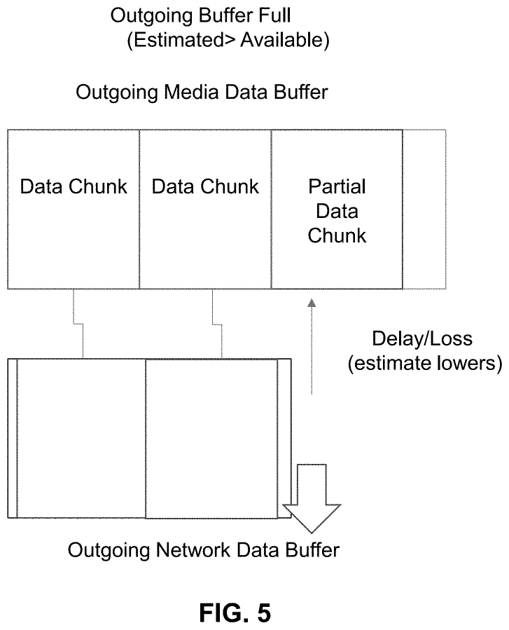

For example, FIG. 5 depicts an example of lowering of transmit bitrate. A sender provides media data from a media data buffer to an outgoing network data buffer prior to media data transmission. Based on outgoing media buffer being full with estimated transmit rate being greater than available transmit rate due to congestion, delays, or packet loss, transmit bit rate can be lowered.

Referring again to FIG. 4, at 408, based on an increase in available transmission bandwidth and data available in a media data buffer being less than requested for transmission in one or more packets, pad or filler data can be inserted into payloads of the one or more packets. For example, if a stream ready-to-send state is indicated, and not enough data is in the data buffer to be transmitted, fill data can be transmitted with media data or fill data can be transmitted if no media data is available. Such scenario can occur if a burst of transmit bandwidth is available, which can be transitory and revert to a former transmit bandwidth level or even lower level. Insertion of a fill data can attempt to reduce a likelihood that burst tokens are built up during a burst of transmit bandwidth, that may be followed by a backoff scenario and corresponding degraded user experience. For example, metrics to evaluate user experience from media playback can be based on: pixel resolution, bit rate, presence of artifacts, peak signal-to-noise ratio (PSNR), structural similarity index measure (SSIM), Video Multi-Method Assessment Fusion (VMAF), or other tools or measurements.

An amount of fill data to insert into one or more packets can be set to fill a payload of a packet having media data and fill data to a maximum transmission unit (MTU) of the packet. Where no media data is available to transmit, fill data can be inserted into one or more subsequent packets to fill such one or more subsequent packets to an MTU size.

A fill pattern or data could include zeros, media data used to increase media quality at a receiver, or a combination thereof. For example, a fill pattern can include information about a next quality level above a current quality level applied at a receiver, such as a Predictive frame (P-frame) or Intra-coded I frames. Fill data can include spatial quality data, temporal quality data (e.g., recomputed motion vectors, interstitial frame data, etc.). In a progressive format, fill data can allow a next level of quality to be displayed at a receiver without waiting for a full new quality frame. Fill data can be used to enhance decoded video and not wait until next level of bandwidth use is cleared.

The following describes a manner to use a variation in bitrates to maintain stable throughput, while opportunistically increasing quality by use of fill data. For example, fill data can include volumetric media that can be encoded as voxels where the quality type is differentiated by edge length. A voxel octree format can be stored in the outgoing buffer, breadth-first. An octree format can be stored in memory such that the root spatial information is the first set of bytes available in the buffer, the lowest quality level for this stream. A next quality level can be subdivided into further voxels, providing higher resolution of the spatial representation. The next further quality levels are subdivided further, increasing to the maximum resolution. As there are available bytes in the outgoing buffer, one or more temporal frames with the root level (lowest quality) can be first added to the outgoing buffer in fill data. As the available bandwidth increases, the next quality level is added to the buffer, this data may be usable to the receiving client to fill in the spatial information prior to the display of the next temporal frame opportunistically in response to the available bitrate, to reduce burst and throttle of data. A data buffer can be arranged such that voxels needed for lower edge length distances are appended or removed and reassembled prior to render and display.

Fill data can include a portion of a predictive frame, such as less than an entirety of a predictive frame or an entirety of a predictive frame. Predictive frames (e.g., P-frames) can be derived based on the desired framerate. Predictive frames can be represented as a delta from prior frame data and provide higher quality frames through increased framerate at an increase in bitrate. In a case of an octree format, data can include a temporal I-frame whereby data to complete this frame is present in the lowest root level, and at one or more subsequent levels. Note that spatial quality can be improved in this octree format by adding data that maps to the next level root nodes, as part of the fill data itself. Inclusion of a P-frame in fill data could encode a next frame difference data. P-frame data may be useful as fill data when extra bandwidth allows. For example, if an I-frame is transmitted, and the next frame is P-frame and has already been encoded, but not acknowledged by this client, the P-frame can be sent and acknowledged reducing skipped frames while the next temporal frame is encoded.

For example, a P-frame can be transmitted at rate X fps and bandwidth is available so the next P-frame can be sent at rate X*2 fps as fill data. A P-frame can be provided to an encoder to increase fluid motion and jump to the now enhanced stream for that rate. Based on a large change in motion vector value, an encoder could opportunistically recompute in a just-in-time manner that would influence client decoder smoothness (e.g., a viewer's perspective shift in virtual reality (VR) or augmented reality (AR)).

In some examples, fill data can include portions of B-frames, to convey an interstitial difference between P-frames.

In some examples, if a packet includes merely fill data and the packet is lost or acknowledgement of receipt is not received by a sender, the sender may not re-transmit such packet that includes merely fill data.

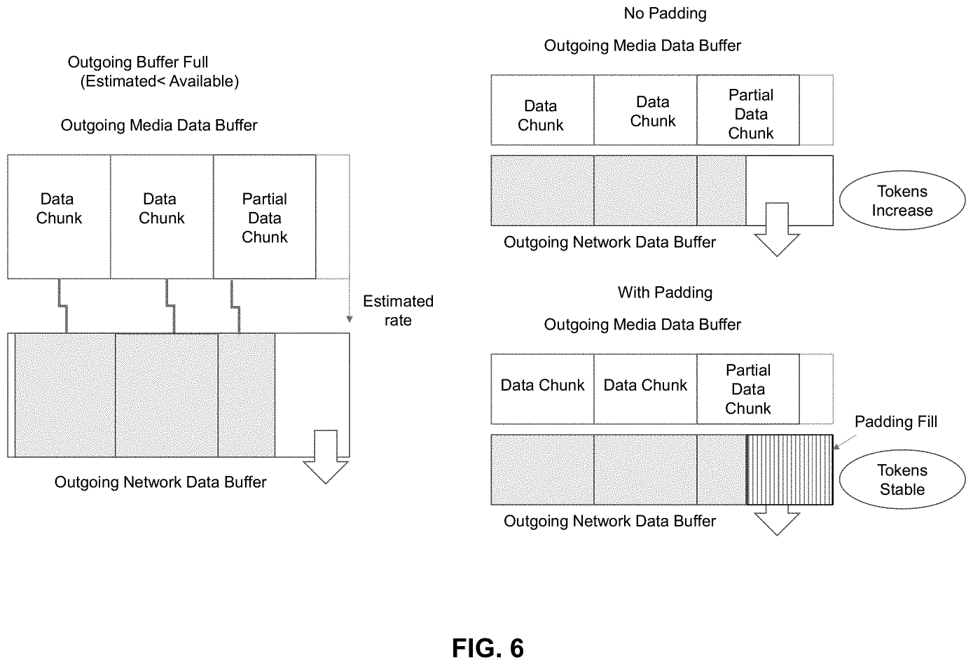

FIG. 6 depicts an example of transmit bitrate increase scenarios. Based on an estimated transmit rate being higher than an available media data transmit rate (Estimated<Available), for a token bucket approach, available tokens can increase by not sending data, which can lead to increased transmission of media data in a burst scenario. However, insertion of filler or padding into one or more packets can lead to available tokens not increasing and potentially avoid a burst scenario.

Referring again to FIG. 4, at 406 and/or 408, changes in available transmit bandwidth can be determined by probing a socket for available bandwidth. For example, a socket can be opened in a non-blocking mode and data sent at a rate that media data is added to the data queue, and the socket can be monitored such that if such operation succeeds in writing bytes to the network interface device. Based on success of writing bytes to the network interface device, transmit bandwidth can be estimated to be a same or higher. However, based on failure to write bytes to the network interface device, transmit bandwidth can be estimated to be falling or lower.

For example, receipt of explicit congestion notification (ECN) markers on a subset of transmitted packets at a sender can indicate congestion in a transmit path and that transmit bandwidth is reduced. Other indicia of increased or decreased bandwidth can be received using congestion notification, such as in-network telemetry (INT).

Congestion control algorithms can be utilized by sender such as Google's Swift, Amazon's SRD, and Data Center TCP (DCTCP), described for example in RFC-8257 (2017). DCTCP is a TCP congestion control scheme whereby when a buffer reaches a threshold, packets are marked with ECN and the end host receives markings and sends the marked packets to a sender. The sender can adjust its transmit rate of packets including media data and/or fill data by adjusting a congestion window (CWND) size to adjust a number of sent packets for which acknowledgement of receipt was not received. Reducing CWND can reduce a packet transmit rate. In response to an ECN, a sender can reduce a CWND size to reduce a number of sent packets for which acknowledgement of receipt was not received. Swift, SRD, DCTCP, and other congestion control schemes can adjust CWND size based on indirect congestion metrics such as packet drops or network latency.

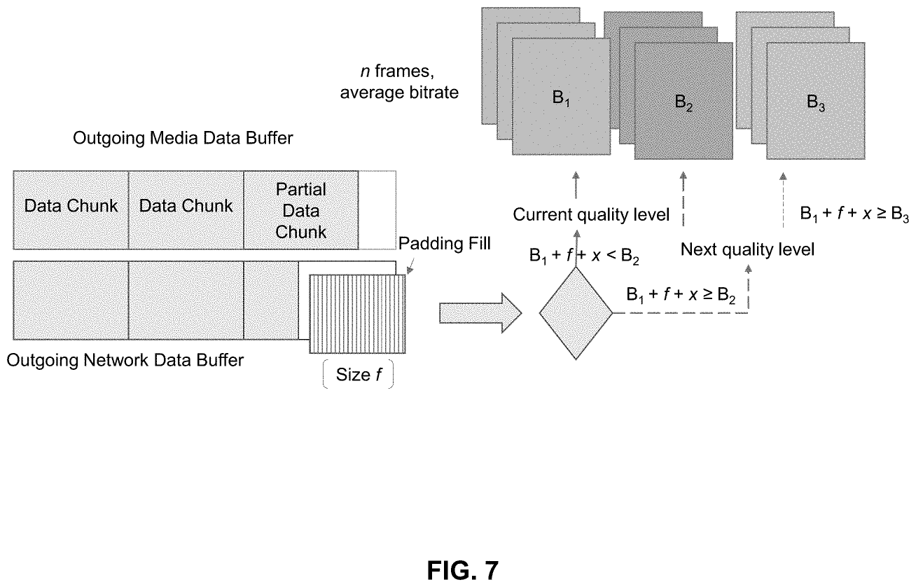

At 410, a media quality level and bitrate profile can be selected based on an amount of fill data and current available transmit bandwidth to a receiver. In some examples, a bit rate can be considered in determining whether to select a different quality level to transmit. FIG. 7 depicts an example of selecting bitrate profiles based on fill data size. For example, a lower level of quality can be selected based on B₁+f+x<B₂, where x represents transmit data margin (in bits), B₁ represents an average number of bits in a lower quality level, B₂ represents an average number of bits in a medium quality level, B₃ represents an average number of bits in a higher quality level, and f represents an amount of fill data added to one or more packets. For example, a medium level of quality can be selected based on B₁+f+x≥B₂ or a higher level of quality can be selected based on B₁+f+x≥B₃. More than three levels of quality can be used.

Referring again to FIG. 4, at 410, based on the increased available transmit bandwidth remaining, transmitted media quality level can be increased at least to a next quality level. For example, if for a number of transmitted frames n, an amount of fill data is greater than a difference between a current quality level and a higher quality level and subject to a margin x, which provides a cushion against transmit bandwidth fluctuating downward, a higher quality level can be selected, up to the maximum quality level defined for that client and stream.

The process can be repeated to probe bandwidth and drain cycles or to drain a token bucket and permit accurate measurement of maximum bandwidth. In some cases, the process can be performed for one or more frames, during an idle time window for media transmission, or when burst traffic is detected in aggressive traffic shaping.

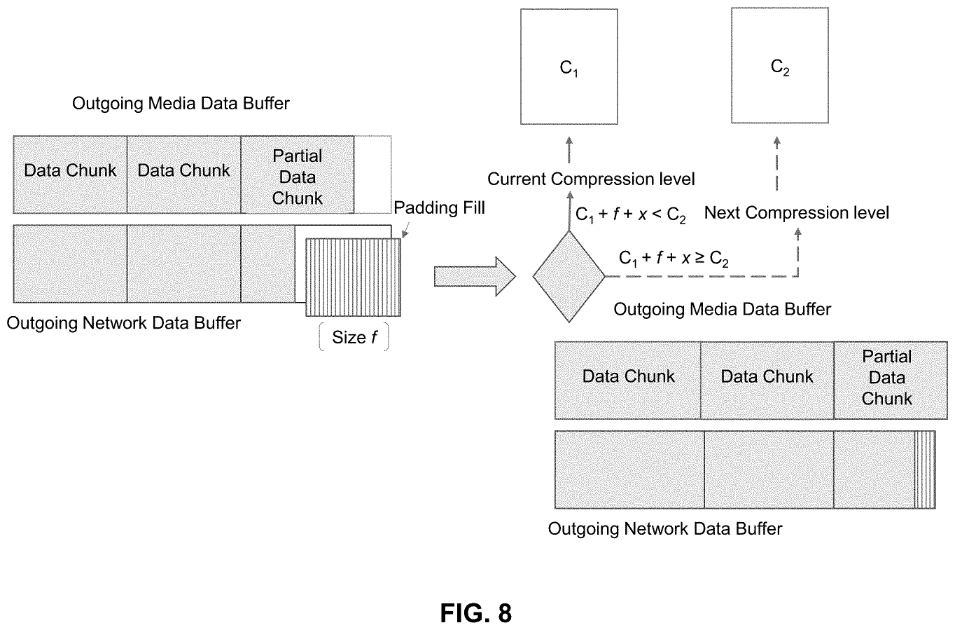

FIG. 8 depicts an example of scaling compression for resource utilization at a sender host server based on transmit bandwidth estimates. To satisfy a media transmit bit rate and maintaining media quality transmitted to one or more receivers, CPU and memory resources can be used to further compress transmitted media. However, if additional media transmit bandwidth is available, a same media quality level can be sent but with less compression and less use of CPU and memory resources. A sender can reduce a compute load while maintaining a quality level of transmitted media when higher transmit bandwidth is available by increasing compression of media. Compression level C₁ can represent a higher media compression level than that of level C₂. For example, use of HEVC to compress media can provide compression level C₁ and use of MPEG to compress media can provide compression level C₂. For example, for compression level C₂ compared to level C₁, CPU utilization and memory usage can be decreased and chunk size can increase. The size of the media can be adjusted to a less intensive compression mechanism that could also reduce resource usage at a sender, but may not improve the quality.

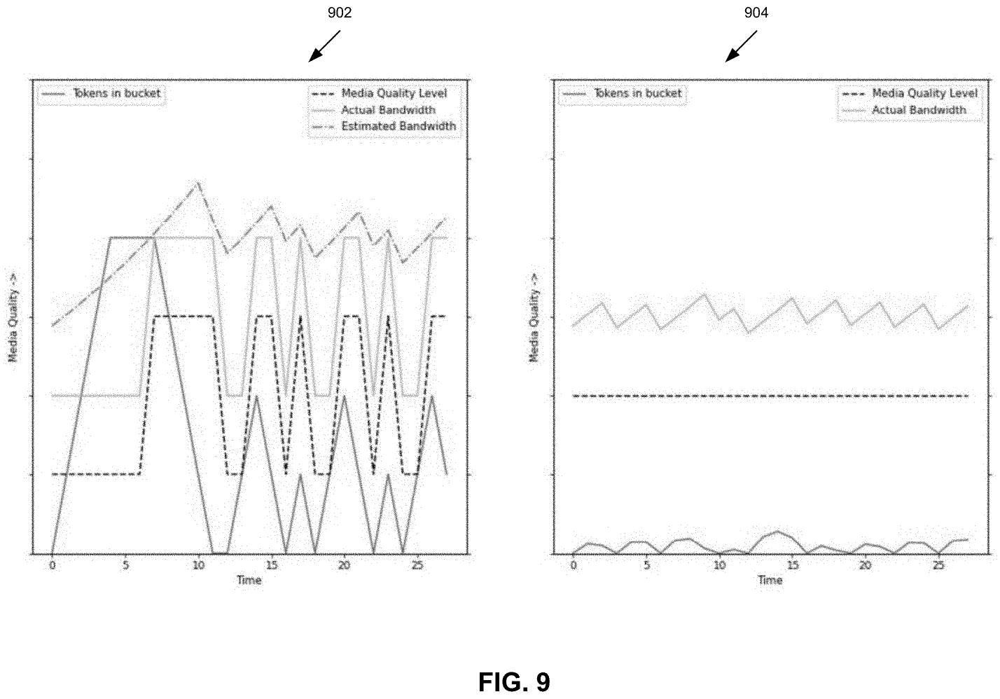

FIG. 9 depicts a characteristic misestimation of bandwidth and effect on media quality. For media quality levels shaped by token buckets can exhibit relatively larger changes in quality levels (902) compared to use of filler patterns as described herein (904).

FIG. 10 depicts an example computing system that can be used in a server or data center. Components of system 1000 (e.g., processor 1010, interface 1012, memory controller 1022, memory 1030, I/O interface 1060, controller 1086, and so forth) to perform operations to determine whether to insert filler or pad data into one or more packets and an amount of filler data to insert, as described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a fixed function or programmable offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 1032 can enable or disable operations to determine whether to insert filler or pad data into one or more packets and an amount of filler data to insert, as described herein

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can perform operations to update mappings of received packets to target processes or devices can be updated, as described herein.

Some examples of network interface 1050 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. An example of a volatile memory include a cache. A non-volatile memory (NVM) device is a memory whose state is determinate even if power is interrupted to the device.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, die-to-die communications, packet-based communications, communications over a device interface, fabric-based communications, and so forth. A die-to-die communications can be consistent with Embedded Multi-Die Interconnect Bridge (EMIB).

FIG. 11 depicts an example system. In this system, IPU 1100 manages performance of one or more processes using one or more of processors 1106, processors 1110, accelerators 1120, memory pool 1130, or servers 1140-0 to 1140-N, where N is an integer of 1 or more. In some examples, processors 1106 of IPU 1100 can execute one or more processes, applications, VMs, containers, microservices, and so forth that request performance of workloads by one or more of: processors 1110, accelerators 1120, memory pool 1130, and/or servers 1140-0 to 1140-N. IPU 1100 can utilize network interface 1102 or one or more device interfaces to communicate with processors 1110, accelerators 1120, memory pool 1130, and/or servers 1140-0 to 1140-N. IPU 1100 can utilize programmable pipeline 1104 to process packets that are to be transmitted from network interface 1102 or packets received from network interface 1102. Programmable pipeline 1104 and/or processors 1106 can be configured to determine whether to insert filler data into one or more packets and an amount of filler or pad data to insert, as described herein.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, serverless computing systems (e.g., Amazon Web Services (AWS) Lambda), content delivery networks (CDN), cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.’”

Illustrative examples of the devices, systems, and methods disclosed herein are provided below. An embodiment of the devices, systems, and methods may include one or more, and combination of, the examples described below.

Example 1 includes one or more examples and includes an apparatus comprising: an interface and circuitry coupled to the interface, the circuitry to: based on increased available bandwidth to transmit media data to a receiver device: based on unavailability of media data, provide fill data into a network data buffer and based on availability of media data, provide the media data into the network data buffer.

Example 2 includes one or more examples, wherein the circuitry is to adjust transmission bandwidth for media data by adjusting a size of a congestion window.

Example 3 includes one or more examples, wherein the provide fill data is to cause burst token accumulation to not accumulate based on increased available bandwidth to transmit media data.

Example 4 includes one or more examples, wherein the fill data is to permit utilization of increased available bandwidth to transmit media data to prevent a burst and backoff scenario.

Example 5 includes one or more examples, wherein the fill data comprises one or more of: spatial quality data, temporal quality data, zero fill, and/or a predictive frame.

Example 6 includes one or more examples, wherein the media comprises one or more of: video, image, and/or audio.

Example 7 includes one or more examples, wherein the circuitry is to transmit a higher quality level of media based on availability of increased available bandwidth for N number of transmitted packets.

Example 8 includes one or more examples, wherein the increased available bandwidth is identified based on information conveyed in-network telemetry (INT).

Example 9 includes one or more examples and includes a server communicatively the circuitry, wherein the server is to provide the media for transmission.

Example 10 includes one or more examples, wherein the receiver device comprises a client device that executes a media player.

Example 11 includes one or more examples and includes at least one non-transitory computer-readable medium comprising instructions stored thereon, that if executed by one or more processors, cause the one or more processors to: based on increased available bandwidth to transmit media data to a receiver device: based on unavailability of media data, provide fill data into a network data buffer and based on availability of media data, provide the media data into the network data buffer.

Example 12 includes one or more examples, wherein the provide fill data is to cause burst token accumulation to not accumulate based on increased available bandwidth to transmit media data.

Example 13 includes one or more examples, wherein the fill data is to permit utilization of increased available bandwidth to transmit media data to prevent a burst and backoff scenario.

Example 14 includes one or more examples, wherein the fill data comprises one or more of: spatial quality data, temporal quality data, zero fill, and/or portion of a predictive frame.

Example 15 includes one or more examples, wherein the media comprises one or more of: video, image, and/or audio.

Example 16 includes one or more examples and includes instructions stored thereon, that if executed by one or more processors, cause the one or more processors to: cause transmission of a higher quality level of media based on availability of increased available bandwidth for N number of transmitted packets.

Example 17 includes one or more examples and includes a method comprising: based on increased available bandwidth to transmit media data to a receiver device: based on unavailability of media data, providing fill data into a network data buffer and based on availability of media data, providing the media data into the network data buffer.

Example 18 includes one or more examples, wherein the fill data permits utilization of increased available bandwidth to transmit media data to prevent a burst and backoff scenario.

Example 19 includes one or more examples, wherein the fill data comprises one or more of: spatial quality data, temporal quality data, zero fill, and/or portion of a predictive frame.

Example 20 includes one or more examples and includes causing transmission of a higher quality level of media based on availability of increased available bandwidth for N number of transmitted packets.

What is claimed is:

1. An apparatus comprising:
an interface and
circuitry coupled to the interface, the circuitry to:
based on increased available bandwidth to transmit media data to a receiver device:
based on unavailability of media data, provide fill data into a network data buffer and
based on availability of media data, provide the media data into the network data buffer.

2. The apparatus of claim 1, wherein the circuitry is to adjust transmission bandwidth for media data by adjusting a size of a congestion window.

3. The apparatus of claim 1, wherein the provide fill data is to cause burst token accumulation to not accumulate based on increased available bandwidth to transmit media data.

4. The apparatus of claim 1, wherein the fill data is to permit utilization of increased available bandwidth to transmit media data to prevent a burst and backoff scenario.

5. The apparatus of claim 1, wherein the fill data comprises one or more of: spatial quality data, temporal quality data, zero fill, and/or a portion of a predictive frame.

6. The apparatus of claim 1, wherein the media comprises one or more of: video, image, and/or audio.

7. The apparatus of claim 1, wherein the circuitry is to transmit a higher quality level of media based on availability of increased available bandwidth for N number of transmitted packets.

8. The apparatus of claim 1, wherein the increased available bandwidth is identified based on information conveyed in-network telemetry (INT).

9. The apparatus of claim 1, comprising:
a server communicatively the circuitry, wherein the server is to provide the media for transmission.

10. The apparatus of claim 1, wherein the receiver device comprises a client device that executes a media player.

11. At least one non-transitory computer-readable medium comprising instructions stored thereon, that if executed by one or more processors, cause the one or more processors to:
based on increased available bandwidth to transmit media data to a receiver device:
based on unavailability of media data, provide fill data into a network data buffer and
based on availability of media data, provide the media data into the network data buffer.

12. The computer-readable medium of claim 11, wherein the provide fill data is to cause burst token accumulation to not accumulate based on increased available bandwidth to transmit media data.

13. The computer-readable medium of claim 11, wherein the fill data is to permit utilization of increased available bandwidth to transmit media data to prevent a burst and backoff scenario.

14. The computer-readable medium of claim 11, wherein the fill data comprises one or more of: spatial quality data, temporal quality data, zero fill, and/or portion of a predictive frame.

15. The computer-readable medium of claim 11, wherein the media comprises one or more of: video, image, and/or audio.

16. The computer-readable medium of claim 11, comprising instructions stored thereon, that if executed by one or more processors, cause the one or more processors to:
cause transmission of a higher quality level of media based on availability of increased available bandwidth for N number of transmitted packets.

17. A method comprising:
based on increased available bandwidth to transmit media data to a receiver device:
based on unavailability of media data, providing fill data into a network data buffer and
based on availability of media data, providing the media data into the network data buffer.

18. The method of claim 17, wherein the fill data permits utilization of increased available bandwidth to transmit media data to prevent a burst and backoff scenario.

19. The method of claim 17, wherein the fill data comprises one or more of: spatial quality data, temporal quality data, zero fill, and/or portion of a predictive frame.

20. The method of claim 17, comprising:
causing transmission of a higher quality level of media based on availability of increased available bandwidth for N number of transmitted packets.
